(19) United States
(12) Patent Application Publication
(10) Pub. No.: US 2006/0098832 A1
(43) Pub. Date: May 11, 2006

(54) Method for amplifying an acoustic signal and corresponding acoustic system

(75) Inventor: Robert Kasanmascheff, Hochstadt (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: Siemens Audiologische Technik GmbH

(21) Appl. No.: 11/263,342

(22) Filed: Oct. 31, 2005

(30) Foreign Application Priority Data
Nov. 8, 2004 (DE) 10 2004 053 776.3

(51) Int. Cl. H04R 25/00

(52) U.S. Cl. 381/312; 381/318; 381/321

(57) ABSTRACT

Method for amplifying an acoustic signal and corresponding acoustic system In acoustic systems, especially with hearing aids, feedback whistling keeps occurring. To avoid this, a limit gain frequency response of the amplification device, which represents the limits of feedback whistling, is thus recorded. On the basis of the curve recorded a required gain frequency response with a number of interpolation points is created, with each interpolation point having a predetermined minimum distance in each case to the limit gain frequency response in at least two different directions. This enables feedback whistling to be largely avoided, even with shifts in resonant frequencies.

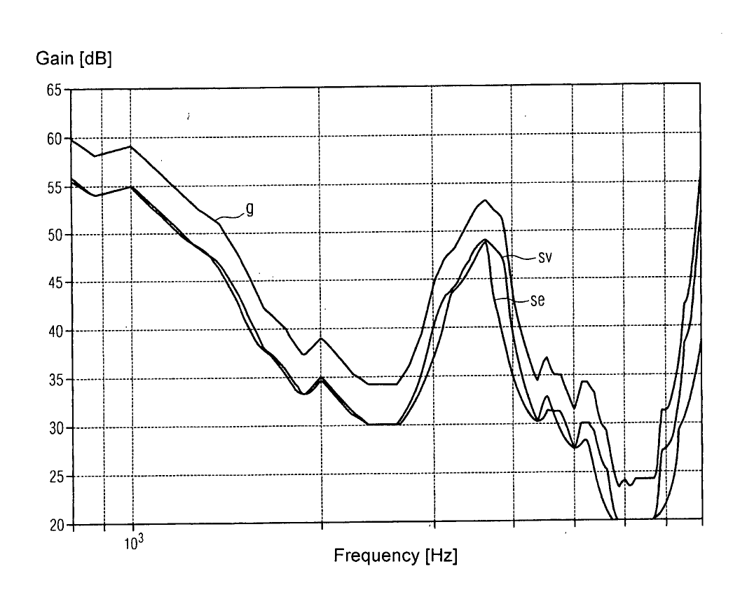

### CROSS REFERENCE TO RELATED APPLICATIONS

This application claims priority to the German application No. 10 2004 053 776.3, filed Nov. 8, 2004 which is incorporated by reference herein in its entirety.

### FIELD OF INVENTION

The present invention relates to a method for amplifying an acoustic signal, especially for a hearing aid, by picking up a limit gain frequency response of the amplification device which represents the limit for feedback whistle. In addition the present invention relates to a corresponding acoustic system.

### BACKGROUND OF INVENTION

To adapt a hearing aid to hearing loss, required gain curves are calculated on the basis of the measured hearing loss. These prescribe the corresponding gain values for generally three input levels in the frequency range. The ambient conditions when wearing a hearing aid make it possible for the amplified signals issued by the hearing aid speaker to be picked up again by the hearing aid microphone. This is especially the case for open supply and with gaps in the seal in the case of closed supply. If the microphone-speaker-feedback path-microphone feedback loop is not attenuating at any frequency, whistling occurs.

### SUMMARY OF INVENTION

The feedback whistling not only disturbs the wearer of the hearing aid but also other people in his or her immediate environment. To avoid the whistling the nominal gain curve is usually reduced somewhat. To this end the amplitude curve of the feedback loop is measured according to its separation at a point and, for each frequency, that gain which represents the limit for feedback or feedback whistling is determined. To prevent whistling the values must always be below this limit gain. Since feedback paths are only static under some conditions and thus the limit gain can be temporally exceeded, the gain is generally reduced to the point at which there is always a minimum distance to be measured limit gain curve.

The prior art described in the two paragraphs above can for example be found in publication DE 101 31 964 A1. To avoid whistling the publication recommends a method for operating a hearing aid in which a gain reduction is undertaken as soon as an interference noise is recognized as such.

In publication 101 59 928 A1 a method for avoiding feedback-related oscillations in a hearing aid is described. When feedback-related oscillations are detected the gain is reduced in an area of low signal level of the input signal and in an area of high signal level of the input signal it is reduced less or is not reduced.

Despite a known reduction from the state of the art in the required gain curve, feedback whistling can however still occur, especially in the area of resonances, since for example the resonant frequencies can change dynamically depending on the ambient conditions.

An object of the present invention is thus to propose a method with which feedback whistling can be more securely prevented. In addition a corresponding acoustic system is to be specified for this purpose.

In accordance with the invention this object is achieved by a method for amplifying an acoustic signal, especially for a hearing aid, by picking up a limit gain frequency response of the amplification device which represents the limit for feedback whistling, and creating a required gain frequency response with a number of interpolation points in which each interpolation point the limit gain frequency response has a predetermined minimum distance in at least two directions in the gain frequency diagram.

In addition, in accordance with the invention there is provision for an acoustic system with an amplification device and a detection device for picking up a limit gain frequency response of the amplification device which represents the limit for feedback whistling as well as for a processing unit to create a required gain frequency curve with a number of interpolation points, in which each interpolation has a minimum prederminable distance to the limit gain frequency response in at least two different directions in the gain frequency diagram and for feeding at the required gain frequency response into the amplification device

In accordance with the present invention this ensures that the amplitude curve, i.e. the gain frequency response of the feedback pa th may not only change in the gain direction because of dynamic processes but can that shifts of resonances in the frequency direction can be tolerated.

Preferably the relevant minimum distance of the required gain frequency response is predetermined by the limit gain frequency response in the horizontal and vertical direction. This means that a minimum distances in the gain direction and in the frequency direction are necessarily adhered to.

The distance between of the required gain frequency response and the limit gain frequency response can be determined in at least a part area of the frequency response using a circle, the center point of said circle being shifted on the curve of the required gain frequency response and the circle always touching the curve of the limit frequency response in this case. In this way the required gain frequency response can be easily calculated as a function of the limit gain fre4uency response while adhering to a minimum distance perpendicular to the curve of the required gain frequency response. In specific other subareas of the frequency response the required gain can be selected to be higher or lower in accordance with other criteria.

Alternatively the distance between the required gain frequency response and the limit gain frequency response can be determined at least in a part area of the frequency response with the aid of an ellipse of which the center point is shifted on the curve of the required gain frequency response and which always touches the curve of the limit gain frequency response in this case. In this way it can be ensured that the minimum distance in the horizontal direction differs from the minimum distance and the vertical direction.

In addition there can be provision for the distance between at the required gain frequency response and the limit gain frequency response to be set differently in at least two frequency ranges. This enables a more targeted reaction to the dynamic behavior of the acoustic system. In particular the minimum distance of the two frequency responses can be kept smaller in frequency ranges which are little affected by dynamic changes.

The present invention will now be explained in greater detail with reference to the enclosed drawing which illustrates the different required gain frequency responses for a measured limit gain frequency response.

### BRIEF DESCRIPTION OF THE DRAWING

The exemplary embodiment described in greater detail below represents a preferred embodiment of the present invention.

### DETAILED DESCRIPTION OF INVENTION

In accordance with the example selected here the gain should be adapted as a function of the measured amplitude response such that a minimum distance is adhered to in two dimensions. This means that the gain curve must maintain a minimum distance not only vertically but also horizontally. To this end the Figure shows a measured limit gain frequency response g for a hearing aid. In the 2,5 kHz and 6 kHz range lie resonances which are caused by the hearing aid when it is being used. In these areas the limit gain at which no attenuation occurs in the feedback circuit is thus comparatively small.

So that the likelihood of the occurrence of feedback whistling it is reduced, in accordance with the prior art, a required gain frequency response sv can be determined, which in relation to the limit gain frequency response g, is shifted vertically downwards, i.e. in the gain direction In this case for example the gain it is reduced by 6 dB at each frequency.

It can easily be seen from the diagram it that in steep areas of the frequency response curves g and sv the horizontal distance between the two curves can be only very small. The result of this is that, for a shift in the actual limit gain frequency response, for example as a result of a change in the position of the hearing aid, the required gain frequency response sv lies above the actual limit gain frequency response in one or more spectral areas. In this case a whistling then occurs in the hearing-aid.

In accordance with the invention the required gain frequency response is thus selectively further reduced so that the required gain frequency response se is produced. This required gain frequency response se also maintains a minimum distance in the horizontal direction, i.e. in the frequency direction, to the limit gain frequency response g.

In the present example the curve se is determined with the aid of an ellipse of which the main axes define the vertical and horizontal distance. In addition the ellipse also defines the minimum distances in the angles deviating from the horizontal and vertical. In other words, when the ellipse is shifted with its center point along the curve se it always only touches the curve g tangentially.

The same of course also applies if the ellipse is shifted above the measured curve g. The required gain curve se then never intersects with the ellipse.

Instead of an ellipse, a circle or another geometric form or another function could be used to determine the required gain frequency response se. A circle would for example ensure an orthogonal distance between the two curves g and se.

In the example shown above the minimum distance between the two frequency response curves is determined over the entire frequency range in the same way. In accordance with an alternative embodiment the distance can be defined in one or more parts of the frequency range with different methods. For example the distance in the lower frequency range, where resonances are hardly ever expected, could be comparatively low and in the higher frequency range could be selected to be correspondingly higher.

A significant advantage of the inventive choice of the required gain frequency response is that the vertical distance to the limit gain frequency response possibly does not have to be so large it since in the case of a purely vertical spacing in accordance with the curve sv to achieve a sufficient horizontal distance, the vertical distance would have had to be significantly greater.

1.-10. (canceled)

11. A method of amplifying an acoustic signal, comprising:
determining a limit gain frequency response of an amplification device representing a limit for the occurrence of feedback whistling; and
determining relative to a gain frequency diagram, a desired gain frequency response comprising a plurality of interpolation points, each interpolation point having in the gain frequency diagram a minimum distance to the limit gain frequency response relative to at least two different directions.

12. The method according to claim 11, wherein the method is implemented in a hearing aid.

13. The method according to claim 11, wherein the at least two different directions comprise a horizontal and a vertical direction in the gain frequency diagram.

14. The method in accordance with claim 11, wherein a distance between the desired gain frequency response and the limit gain frequency response is determined relative to at least a part frequency area of the limit gain frequency response using an ellipse, a center of the ellipse defining the desired gain frequency response when the ellipse is shifted along the limit gain frequency response while the ellipse always touches the limit gain frequency response at an outer contour of the ellipse.

15. The method in accordance with claim 11, wherein the desired gain frequency response is determined relative to at least a part frequency area of the limit gain frequency response using an ellipse, a center of the ellipse defining the desired gain frequency response when the ellipse is shifted along the limit gain frequency response while the ellipse always touches the limit gain frequency response at an outer contour of the ellipse.

16. The method in accordance with claim 11, wherein a distance between the desired gain frequency response and the limit gain frequency response is determined relative to at least a part frequency area of the limit gain frequency response using a circle, the center of the circle defining the desired gain frequency response when the circle is shifted along the limit gain frequency response while the circle always touches the limit gain frequency response at an outer contour of the circle.

17. The method in accordance with claim 11, wherein the desired gain frequency response is determined relative to at least a part frequency area of the limit gain frequency response using a circle, the center of the circle defining the desired gain frequency response when the circle is shifted along the limit gain frequency response while the circle always touches the limit gain frequency response at an outer contour of the circle.

18. The method in accordance with claim 11, wherein the minimum distance between the desired gain frequency response and the limit gain frequency response is different relative to at least two different frequency ranges.

19. An acoustic system, comprising:
an amplification device;
an acquisition device for determining a limit gain frequency response of the amplification device, the limit gain frequency response representing a limit for the occurrence of feedback whistling; and
a processing device configured to:
determine a desired gain frequency response comprising a plurality of interpolation points, each interpolation point having in the gain frequency diagram a minimum distance to the limit gain frequency response relative to at least two different direction; and adjust the amplification device according to the desired gain frequency response.

20. The acoustic system in accordance with claim 19, wherein the processing device is configured to determine the minimum distance in a horizontal and a vertical direction.

21. The acoustic system in accordance with claim 19, wherein the processing device determines a distance between the desired gain frequency response and the limit gain frequency response relative to at least a part frequency area of the limit gain frequency response using an ellipse, a center of the ellipse defining the desired gain frequency response when the ellipse is shifted along the limit gain frequency response while the ellipse always touches the limit gain frequency response at an outer contour of the ellipse.

22. The acoustic system in accordance with claim 19, wherein the processing device determines the desired gain frequency response relative to at least a part frequency area of the limit gain frequency response using an ellipse, a center of the ellipse defining the desired gain frequency response when the ellipse is shifted along the limit gain frequency response while the ellipse always touches the limit gain frequency response at an outer contour of the ellipse.

23. The acoustic system in accordance with claim 19, wherein the processing device determines a distance between the desired gain frequency response and the limit gain frequency response relative to at least a part frequency area of the limit gain frequency response using a circle, the center of the circle defining the desired gain frequency response when the circle is shifted along the limit gain frequency response while the circle always touches the limit gain frequency response at an outer contour of the circle.

24. The acoustic system in accordance with claim 19, wherein the processing device the desired gain frequency response relative to at least a part frequency area of the limit gain frequency response using a circle, the center of the circle defining the desired gain frequency response when the circle is shifted along the limit gain frequency response while the circle always touches the limit gain frequency response at an outer contour of the circle.

25. The acoustic system in accordance with claim 19, wherein the minimum distance between the desired gain frequency response and the limit gain frequency response is set differently relative to at least two different frequency ranges.
